(19) United States
(12) Patent Application Publication
(10) Pub. No.: US 2011/0042277 A1
(43) Pub. Date: Feb. 24, 2011

(54) Method for Separating Biochar from Wood Ash

(76) Inventors: Cedric BRIENS, London (CA); Franco Berruti, London (CA); Lorenzo Ferrante, London (CA)

Correspondence Address: VICTORIA DONNELLY, PO BOX 24001, HAZELDEAN RPO, KANATA, ON, K2M 2C3, CA

(21) Appl. No.: 12/854,865

(22) Filed: Aug. 11, 2010

(30) Foreign Application Priority Data
Aug. 24, 2009 (CA) 2,676,514

(51) Int. Cl. B03B 7/00; B03B 5/00

(52) U.S. Cl. 209/12.1

(57) ABSTRACT

Wood ash residues are a complex ternary mixture of small stones, biochar particles and ash. The present application shows how a combination of physical separation processes can be applied to the efficient extraction of a biochar-rich fraction. Two different techniques were tested: segregation and elutriation. The effects of the fluidization velocity on both of the processes were investigated respectively. Either technique happened to be ineffective, on its own, to obtain high purity biochar. However, a combination of segregation and elutriation proved to recover 78% of the biochar with a purity of 90%.

### RELATED APPLICATIONS

The present application claims benefit from the Canadian patent application serial number 2,676,514 filed on Aug. 24, 2009 for “Method for Separating Biochar from Wood Ash”, the entire contents of which are incorporated herein by reference.

### FIELD OF THE INVENTION

The present invention relates to separating or extracting materials by physical or chemical methods, and in particular, to separating biochar from wood ash.

### BACKGROUND OF THE INVENTION

Biochar is charcoal, which is a high-carbon, fine-grained residue which today is produced through modern pyrolysis processes of biomass. Pyrolysis is the direct thermal decomposition of biomass in the absence of oxygen to obtain an array of solid (biochar), liquid (bio-oil) and gas (syngas) products. Biochar is a stable solid and rich in carbon content.

Since biochar can sequester carbon in the soil for hundreds to thousands of years, it has received considerable interest as a potential tool to slow global warming.

Biochar can store carbon in the ground, potentially making a noticeable reduction in atmospheric green house gas levels; and its presence in the earth can improve water quality, increase soil fertility, raise agricultural productivity, reduce pressure on old growth forests, reduce leaching of nutrients, reduce soil acidity, and reduce irrigation and fertilizer requirements.

Biochar can be used to sequester carbon on extremely long time scales. Under some circumstances, the addition of biochar to the soil has been found to accelerate the mineralization of the existing soil organic matter.

Biochar can be used as a soil amendment to increase plant growth yield, improve water quality, reduce soil emissions of green house gases. Biochar also has use as dietary supplement for animals, and traditionally as charcoal biscuits for humans. The effects of this are to provide additional minerals, maintain a healthy digestive system, reduce flatulence, and reduce the odour of and ammonia emissions from slurry.

Biochar can be directly substituted for any application that uses coal for the production of energy.

Therefore, there is a need in the industry for developing improved alternative methods for extracting biochar from existing industrial materials, and in particular, from waste materials.

### SUMMARY OF THE INVENTION

It is therefore an object of the invention to provide an improved or alternative method for separating biochar from wood ash.

The method uses a combination of two processes in series: segregation followed by elutriation. In the segregation process, as the first stage, most of the char particles are segregated at the top of a fluidized bed. Afterwards, during the second stage, elutriation, the char particles remain in the fluidized bed whereas the fine ash rich fraction is elutriated.

The combined process separates the original wood ash in three fractions: the bottom segregation fraction is mainly composed of little stones; the bottom elutriation fraction is mainly composed of large carbonaceous black particles; and the third phase is mainly composed of fine light ash particles which leave the column during elutriation.

The bottom elutriation fraction represents 40% of the original wood ash and has a high content of char of about 90%). More than 78% of the char contained in the original wood ash has been recovered in this phase, which represents the desired product of the separation process.

### BRIEF DESCRIPTION OF THE DRAWINGS

Embodiments of the invention will be further described with the reference to the drawings, in which:

FIG. 1 shows a schematic diagram of the fluidized bed unit used in the segregation step of the embodiment of the present invention;

FIG. 2 shows a schematic diagram of the fluidized bed unit with extended column section, used in the elutriation step of the embodiment of the invention;

FIG. 3 shows a gas distributor used in embodiments of the present invention;

FIG. 4 shows the gas distributor of FIG. 3 covered with filter paper;

FIG. 5 illustrates a distribution of products produced in a segregation followed by elutriation;

FIG. 6 shows a diagram illustrating char recovery in the top of the fluidized bed at the end of the segregation as a function of the segregation velocity;

FIG. 7 shows a diagram illustrating char content in the top bed layer as function of the segregation velocity;

FIG. 8 shows a diagram illustrating char enrichment in the bed during an elutriation experiment for different gas velocities;

FIG. 9 shows a diagram illustrating char recovery in the bed during an elutriation experiment for different gas velocities;

FIG. 10 shows a table containing experimental results related to the three replicate experiments of segregation followed by elutriation;

FIG. 11 illustrates char partition in a segregation followed by elutriation process; and

FIG. 12 illustrates carbon partition in a segregation followed by elutriation process.

### DETAILED DESCRIPTION OF THE EMBODIMENTS OF THE INVENTION

### Terminology

The terms “biochar” and “char” will be used in the patent application interchangeably, as well as the terms “fluidized bed” and “bed”.

### I. Introduction

The embodiments of the present invention present the results of studying and identifying physical processes that could be used for recovering biochar from wood ash. Two basic processes that were studied include segregation in a fluidized bed and elutriation from a fluidized bed, both separation processes being driven by differences in particle size and density.

### II. Experimental Apparatus And Technique

### II.1. Experimental Apparatus

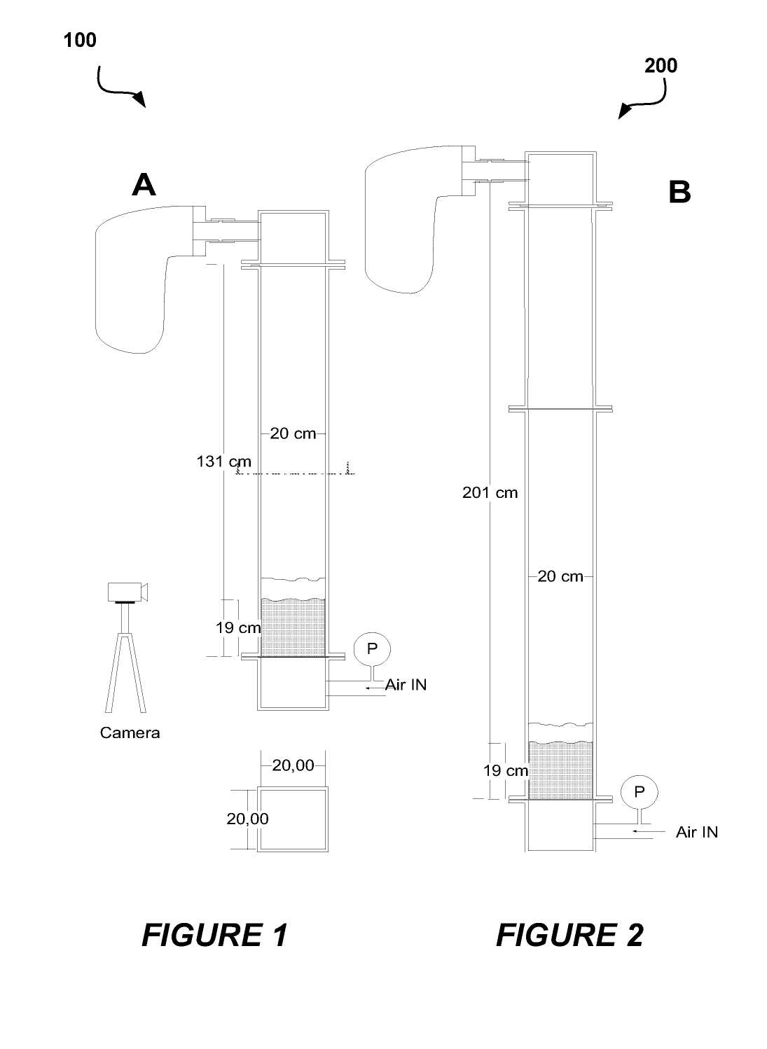

A transparent fluidized bed was used for the experiments. A schematic diagram of the fluidized bed unit 100 is shown in FIG. 1. The fluidization column is 131 cm high, and with a square cross section of 20 cm×20 cm.

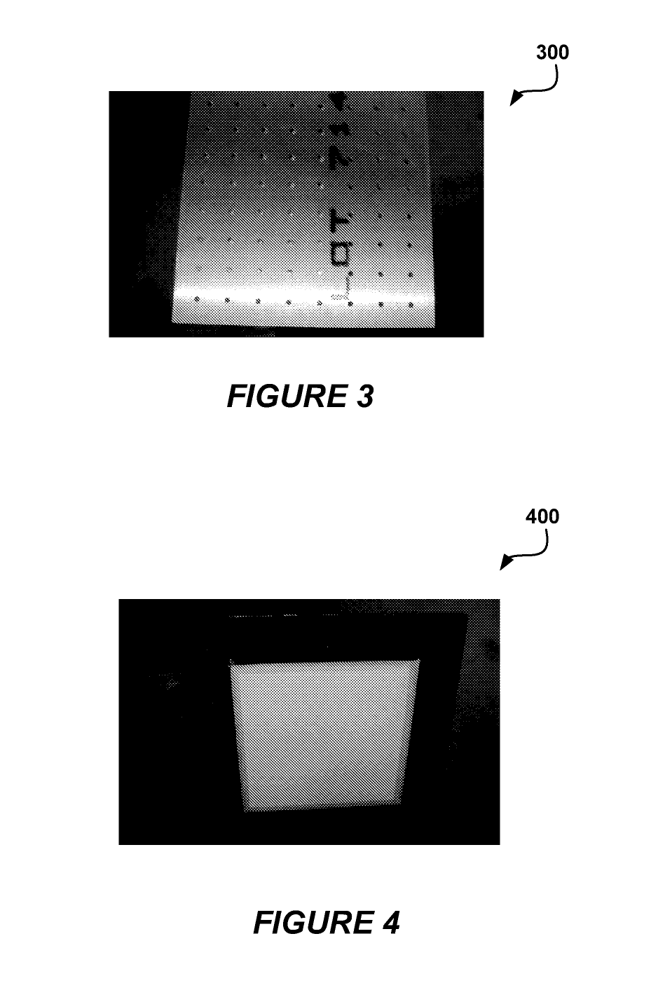

Two different air distributors were used for this study. Each of them has of a perforated plate with 64 holes with a diameter of either 3 mm or 4 mm. The plate with 3mm holes is used for the segregation experiments; in order to achieve a better air distribution and prevent the particles draining through the holes the plate was covered with two layers of filter paper. FIG. 3 shows a gas distributor 300, and FIG. 4 shows the gas distributor covered with filter paper, which is designated by reference numeral 400. The plate with 4 mm holes is used for the elutriation experiments. In this case, a layer of porous material with high porosity has been placed at the bottom of the plate to prevent the draining of the particles and to control the distributor pressure drops at high volumetric flow rates.

The flow rate of the fluidizing gas has been regulated by an Omega rotameter for low fluidizing gas superficial velocities (from 0 to 2.7 cm/s) or by three sonic nozzles (with a throat diameter of 3, 4 and 6 mm respectively) for high fluidization velocities (from 5 to 100 cm/s).

The air exiting the fluidization column goes through a fabric filter bag, which is used to collect all the particles elutriated from the bed.

During the elutriation experiments, the freeboard has been extended by adding an additional column section, to achieve an overall column height of 2.01 m and thus improve separation by ensuring that the column height is larger than the Transport Disengaging Height. The extended fluidized bed unit 200 is shown in FIG. 2.

A digital camera beside the bed has recorded any evolution in the fluidized bed 100 or 200. The camera has been used, in particular, to monitor segregation phenomena within the bed.

### II.2. Analytical Methods

### Elemental Analysis

All the carbon analysis have been performed with a FLASH 2000 Series—CHNS/O Analyzer from Thermo Fisher Scientific.

In standard analysis, 20 grams of material are ground with a Mortar and Pestle to obtain a fine and homogeneous powder; a sample of the final powder is analyzed with the elemental analyzer which provides the concentration of carbon, hydrogen, nitrogen and sulfur.

### Moisture Content Analysis

The moisture content of the original sample has been estimated by weight lost of the sample after oven drying for 6 hr at 120 Celsius. The weight lost of the sample is assumed to be due to the evaporation of the water in the sample.

### II.3. Materials

Wood ash residues provided by WoodAsh Industries Inc. have been used as original material to be separated. The sample is a mixture composed of three fractions: small stones, biochar particles resulting from an incomplete combustion of wood, and ash.

Since ash and stones do not contain any carbon, carbon was used to identify biochar.

From the original wood ash, black carbonaceous particles that could clearly be identified as char were sampled and analyzed; their mean carbon content is 72.5 wt %. In this patent application, the amount of char has been estimated by dividing the amount of carbon by the carbon mass fraction of a typical char particle (0.725).Based on this assumption initial value of char content in the wood ash is 48%.

Table II.1 summarizes the results of the carbon and moisture analysis.

TABLE II.1
Moisture and carbon content in the original sample.

| | |
|---|---|
| Carbon content | 35 wt % |
| Moisture content | 10.1 wt % |
| Char content | 48 wt % |

### II.4. Design of the Experimental Program

The separation of the carbon rich fraction from the rest of the material has been studied. As a first step, two different separation techniques were studied separately: segregation and elutriation. Afterward, the two techniques were combined, and a series of three tests of segregation followed by elutriation were performed.

In the following sections of this patent application, the conditions of the segregation, elutriation and “segregation followed by elutriation” experiments are described. In particular, this patent application describes an experimental procedure, data analysis technique and operating conditions utilized for the tests.

### II.4.1. Segregation In Bubbling Fluidized Bed

In a segregation experiment a bed of particles is aerated with gas at low velocities. When a mixture of solids composed of particles with different characteristics (e.g. density or size) is fluidized at low fluidization velocities, the heavier particles tend to settle in the lower part of the bed and the lighter particles segregate at the top of the bed.

With fluidization velocities, which are much higher than the minimum fluidization velocity, the bed tends to be well mixed and there is no segregation. On the other hand, segregation can occur at velocities just above the minimum fluidization velocity, but, if the velocity is too low, segregation will be too slow for a practical process. Therefore it is important to identify the best fluidization velocity, or a range of suitable fluidization velocities.

### Experimental Procedure

For each regular experiment, the run time was 15 minutes and the following procedure was applied:
Initially, 4.5 kg of wood ash are loaded in the fluidization column.
Once the bed is closed, the video recording of the bed through a side wall starts.
The fluidizing gas is rapidly set to its desired value.
The bed side view is recorded for 10 minutes after the start of the fluidization and the video is then saved for future data analysis.
The gas flow is shut off and the experiment ends.
At the end of the test the lid of the column is removed and the upper part of the bed (the segregated fraction) is carefully vacuumed from the top. The remaining part of the bed is then collected.

### Data Analysis

At the end of the test each collected fraction is weighted and analyzed for carbon content. The char recovery efficiency and the final bed purity are then calculated.

The char recovery efficiency is calculated from the ratio of the mass of recovered char to the mass of the char in the original bed. The purity is the char weight fraction in the recovered char-rich fraction.

The video recording of the bed side has been acquired for future analysis. It was useful to estimate how quickly segregation occurred.

### Investigated Experimental Conditions

A total of 8 different segregation tests were performed. The tests were designed to determine the effects of the fluidization velocity on segregation. Table II 2 below provides a detailed list of the test conditions.

In the first series of tests (S1 to S5), the fluidization velocity was varied over a wide range (from 0.2 to 0.4 m/s). The results showed some inconsistency due to the bad homogeneity of the material used; wood ash coming from different containers had different contents of char, ash and stones. Therefore, a second series of segregation tests was performed (S6 to S8):15 kg have been mixed and successively divided in three beds. In the tests S6-S8, the fluidization velocity has been varied in a tighter range around the optimal condition (V_{g}=2.3-3 m/s).

TABLE II 2
List of the performed segregation experiments.

| | Bed | |
|---|---|---|
| Test N | weight | V_{g} (m/s) |
| S1 | 4.5 Kg | 0.2 |
| S2 | 4.5 Kg | 0.25 |
| S3 | 4.5 Kg | 0.3 |
| S4 | 4.5 Kg | 0.35 |
| S5 | 4.5 Kg | 0.4 |
| S6 | 4.5 Kg | 0.23 |
| S7 | 4.5 Kg | 0.25 |
| S8 | 4.5 Kg | 0.3 |

### II.4.2. Elutriation Experiments

In elutriation experiment, a bed of particles is aerated with gas at high velocities. While the heavier and larger particles stay in the bed, the lighter and smaller particles are carried by the gas exiting the column.

### Experimental Procedure

For each regular experiment, the run time was 25 minutes and the following procedure was applied:
Initially, 4.5 kg of wood ash are loaded in the fluidization column.
Before the experiment, the filter bag at the output of the fluidization column is cleaned and weighed.
The fluidizing gas is rapidly set to its desired value.
At fixed time intervals, the fluidizing gas is stopped and the filter at the output of the bed is weighted and its content collected.
At the end of the test, the remaining bed is collected.

### Data Analysis

The difference between the weight of filter bag before the test and the weight of the bag at a given time tᵢ indicates the amount of particles elutriated from the bed during the given time tᵢ.

The char recovery efficiency is calculated as ratio of the mass of char in the bed at a certain time to the mass of char in the original bed. The purity is the weight percentage of char in the bed.

In the results and discussion section, the calculated variables are reported as a function of time for different tests.

### Investigated Experimental Conditions

The effect of the fluidization velocity on the segregation efficiency has been investigated. A detailed list of the investigated conditions is reported in Table II 3.

TABLE II 3
List of the performed elutriation experiments.

| | Vg | | | | | |
|---|---|---|---|---|---|---|
| Test N. | (m/s) | Sampling time (min) | | | | |
| EL1 | 1.4 | 2 | 5 | 10 | 15 | 25 |
| EL2 | 1.2 | 2 | 5 | 10 | 15 | 25 |
| EL3 | 1 | 2 | 5 | 10 | 15 | 25 |
| EL4 | 0.8 | 2 | 5 | 10 | 15 | 25 |
| EL5 | 0.6 | 2 | 5 | 10 | 15 | 25 |

### II.4.3. Segregation Followed By Elutriation Experiments

Neither segregation nor elutriation alone were able to achieve high char recovery efficiency and high char purity. The two techniques were therefore applied in succession.

In a set of three experiments, a bed of wood ash was segregated, and the top fraction was then subjected to elutriation.

The velocities and the duration of the two phases of the experiment were chosen from the optimal conditions identified in the previous tests: a fluidization velocity of about 0.25 m/s and a duration of about 10 minutes for the segregation step, and a velocity of about 0.6 m/s and a duration of about 15 minutes for the elutriation step.

### Experimental Procedure

For each regular experiment, the run time was 25 minutes and the following procedure was applied:
Before starting the series of experiments all the wood ash samples had been mixed to start from the same wood ash.

Segregation phase:
4.5 kg of wood ash are loaded in the fluidization column for the initial segregation.
Before the experiment, the filter bag at the output of the fluidization column is cleaned and weighed
The fluidizing gas is rapidly set to its desired value, and the segregation is carried for 10 minutes.
After 10 minutes, the gas flow is shut off and the experiment ends.
At the end of the segregation phase, the lid of the column is removed and upper part of the bed (the segregated fraction) is carefully vacuumed from the top. Successively the remaining part of the bed is collected

Elutriation phase
2.5 kg of the top segregated layer from the elutriation phase are loaded in the fluidization column.
Before the experiment, the filter bag at the output of the fluidization column is cleaned and weighed
The fluidization gas is rapidly set to its desired value. (V_{g}=0.6 m/s)
After 15 minutes the gas is stopped, the filter at the output of the bed is weighted and its content collected.
At the end of the test, the remaining bed is collected.

### Data Analysis

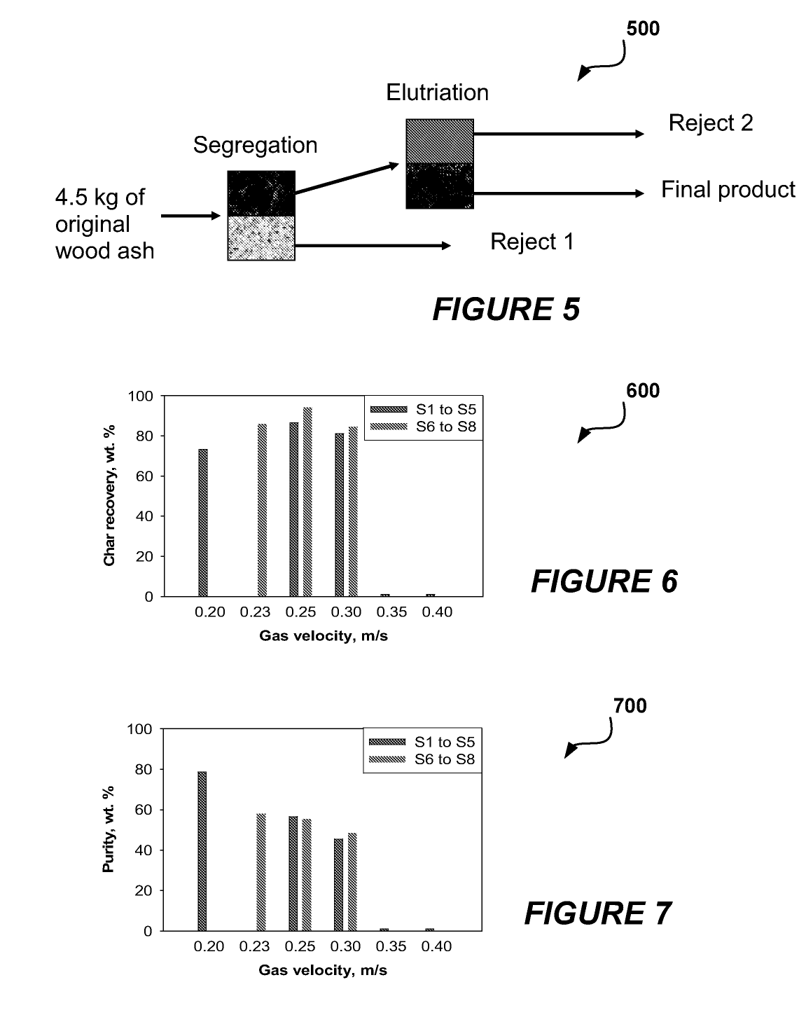

At the end of the tests, three fractions are collected: the bottom of the segregated bed, the bottom bed after the elutriation and the elutriated fraction. A diagram 500 of FIG. 5 shows the distribution of the products.

Each fraction was weighted and analyzed for carbon content.

The char recovery efficiency is calculated as the ratio of the mass of char in the “Final Product” to the mass of char in the original bed. The purity is the weight percentage of char in the “Final Product”.

### III. Preliminary Tests Results

### III.1. Segregation Results

As explained in section II.3, the possibility of using segregation in the fluidized bed to separate char particles from wood ash has been studied. Segregation was performed at different fluidization velocities, in order to identify the velocity which maximizes char segregation.

Table III.1 below summarizes the results of eight different segregation experiments. In the first series of tests (S1 to S5), the fluidization velocity was varied over a wide range (from 0.2 to 0.4 m/s). For gas velocities lower than 0.2 m/s, the bed was not properly fluidized. In the first two experiments (S1 and S2), the fraction of heavy particles was segregated at the bottom of the bed: this fraction was mainly composed of little stones and large char particles. At velocities higher than 0.35 m/s, the bed was homogeneously mixed and no segregation could be observed.

FIG. 6 shows a diagram 600 illustrating char recovery in the top of the fluidized bed at the end of the segregation as a function of the segregation velocity.

FIG. 7 shows a diagram 700 illustrating char content in the top bed layer as function of the segregation velocity.

FIGS. 6 and 7 show that at a fluidization velocity of 0.2 m/s, a large part of the bed deposited at the bottom of about 55% in mass, and the upper part of the bed was particularly rich in carbon. However the deposited fraction contained a large amount of carbon resulting in a relatively poor char recovery. At a fluidization velocity of 0.25 m/s, a smaller amount of particles deposited at the bottom of the bed, resulting in a high char recovery but relatively poor char purity

As the aim of this invention is to separate the char from all the rest of the particles, therefore it is beneficial to recover most of the char in a single fraction. Based on the objective, it has been performed a second series of experiments at a velocity of about 0.25 m/s, the velocity that seems to maximize the char recovery,. The experiments S6-S8 confirmed the previous results and demonstrate the good reproducibility of the data.

From the first segregation experiments, it can be concluded that it is impossible to simultaneously achieve high recovery and high efficiency in a single segregation step. In order to maximize the char recovery, the segregation has to be running at 0.25m/s.

TABLE III.1
Experimental results of segregation experiments

| | | | Fraction | | | | | | | |
|---|---|---|---|---|---|---|---|---|---|---|
| | | | segregated | Carbon | Char % | Char | C % | % Char | | |
| | Gas | Segregated | at the | in the | in the | at the | in the | in the | Char at | Char |
| Run | velocity | mass (g) | bottom | bottom | bottom | bottom | top | top bed | the top | recovery % |
| S1 | 0.20 | 2486.4 | 55% | 16.0% | 22.1% | 549 | 0.57 | 78.6% | 1583 | 73% |
| S2 | 0.25 | 1192.8 | 27% | 14.0% | 19.3% | 230 | 0.41 | 56.6% | 1870 | 87% |
| S3 | 0.30 | 650 | 14% | 13.0% | 17.9% | 117 | 0.33 | 45.5% | 1752 | 81% |
| S4 | 0.35 | 0 | 0% | 0.0% | 0.0% | 0 | | 0.0% | 0 | 1% |
| S5 | 0.40 | 0 | 0% | 0.0% | 0.0% | 0 | | 0.0% | 0 | 1% |
| S6 | 0.23 | 1298 | 29% | 8.6% | 11.8% | 154 | 0.42 | 57.9% | 1855 | 86% |
| S7 | 0.25 | 818 | 18% | 6.9% | 9.5% | 78 | 0.4 | 55.2% | 2031 | 94% |
| S8 | 0.30 | 720 | 16% | 13.0% | 17.9% | 129 | 0.35 | 48.3% | 1825 | 84% |

### III.2. Elutriation

As explained in section II.4, the possibility of applying elutriation to remove light ash has been investigated. Elutriation was performed at different fluidization velocities in order to identify the velocity that maximizes the segregation of char from the remaining particles.

Table III.2 below summarizes the experimental results for various elutriation conditions. During all the experiments, fine gray powders were elutriated from the bed. A first column of Table III.2 shows that increasing the fluidization velocity increases the fraction of particles that were elutriated.

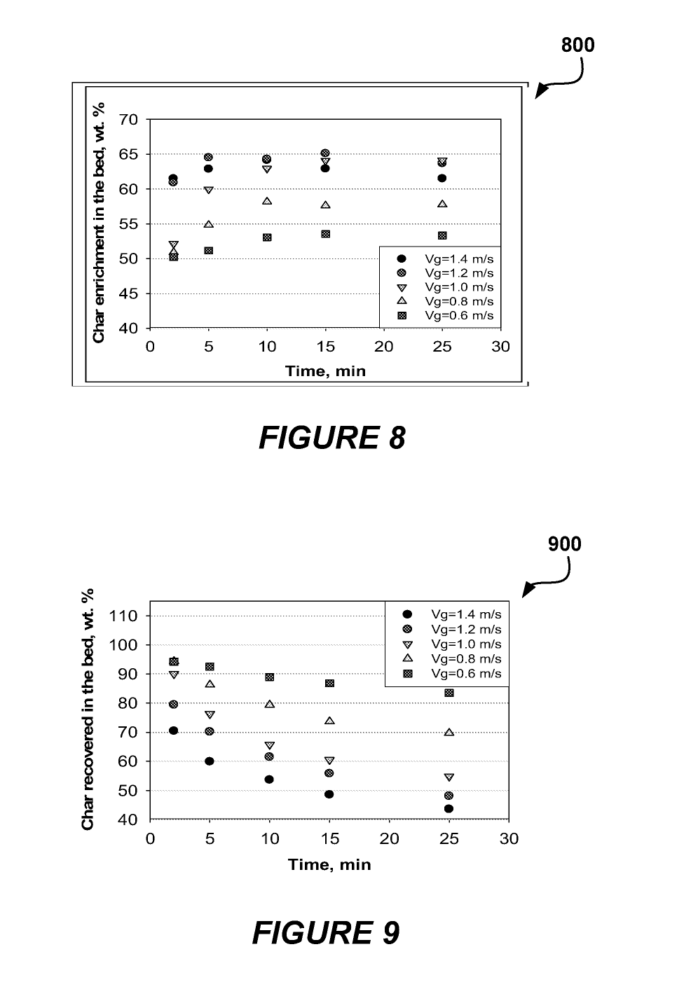

FIG. 8 shows a diagram 800, illustrating char enrichment in the bed during an elutriation experiment for different gas velocities.

FIG. 9 shows a diagram 900 illustrating char recovery in the bed during an elutriation experiment for different gas velocities.

FIG. 8 shows the trends of the char content in the bed during the time. It can be noticed that:
Over the first minute of elutriation, the char percentage content of the bed increases, which suggests that ash is leaving the bed;
After this initial phase of growth, the carbon concentration stabilizes. This phenomenon is due to an increase in the char elutriation from the bed, which is confirmed from the increase of the char percentage in the elutriate during the time; see table III.2 below.
At high gas velocities between about 1.2 and 1.4 m/s, and after 15 minutes of elutriation, the char content in the bed is decreasing, which suggests that all the fine ash particles have left the bed while some char is still leaving the bed.

In FIG. 9, the char recovery in the bed is reported as a function of time for various fluidization velocities. Higher velocities lead to lower char recoveries.

TABLE III.2
Experimental results of elutriation experiments
E1 Vg = 1.4 m/s

| | | | | | % of char | |
|---|---|---|---|---|---|---|
| Time | Mass | | | char el. | in the | Char |
| (minutes) | Elutriated | % C | Char % | (g) | final bed | recovery |
| 2 | 2026 | 22.82 | 0.31 | 638 | 62% | 70% |
| 5 | 416 | 39.68 | 0.55 | 865 | 63% | 60% |
| 10 | 251 | 39.04 | 0.54 | 1001 | 64% | 54% |
| 15 | 139.5 | 57.09 | 0.79 | 1110 | 63% | 49% |
| 25 | 135 | 57.3 | 0.79 | 1217 | 62% | 44% |
| | | | | | % of char | |
| Time | Mass | | | | in the | Char |
| (minutes) | Elutriated | % C | Char % | char el. | final bed | recovery |

E2 Vg = 1.2 m/s

| | | | | | | |
|---|---|---|---|---|---|---|
| 2 | 1682.5 | 19.1 | 0.26 | 443 | 61% | 79% |
| 5 | 467.5 | 31.02 | 0.43 | 643 | 65% | 70% |
| 10 | 283.5 | 47.89 | 0.66 | 831 | 64% | 62% |
| 15 | 214.5 | 41.59 | 0.57 | 954 | 65% | 56% |
| 25 | 219.5 | 54.92 | 0.76 | 1120 | 64% | 48% |

E3 Vg = 1.0 m/s

| | | | | | | |
|---|---|---|---|---|---|---|
| 2 | 771 | 20.22 | 0.28 | 215 | 52% | 90% |
| 5 | 982 | 21.97 | 0.30 | 513 | 60% | 76% |
| 10 | 491 | 33.56 | 0.46 | 740 | 63% | 66% |
| 15 | 215.5 | 37.78 | 0.52 | 852 | 64% | 61% |
| 25 | 195.5 | 46.27 | 0.64 | 977 | 64% | 55% |

E4 Vg = 0.8 m/s

| | | | | | | |
|---|---|---|---|---|---|---|
| 2 | 495.5 | 17.87 | 0.25 | 122 | 51% | 94% |
| 5 | 606 | 20.9 | 0.29 | 297 | 55% | 86% |
| 10 | 452 | 23.89 | 0.33 | 446 | 58% | 79% |
| 15 | 183.5 | 48.49 | 0.67 | 568 | 58% | 74% |
| 25 | 157 | 39.84 | 0.55 | 655 | 58% | 70% |

E5 Vg = 0.6 m/s

| | | | | | | |
|---|---|---|---|---|---|---|
| 2 | 448.5 | 20.37 | 0.28 | 126 | 50% | 94% |
| 5 | 148 | 18.07 | 0.25 | 163 | 51% | 92% |
| 10 | 285 | 19.55 | 0.27 | 240 | 53% | 89% |
| 15 | 117 | 28.35 | 0.39 | 286 | 54% | 87% |
| 25 | 120.5 | 43.27 | 0.60 | 357 | 53% | 83% |

By comparing FIGS. 8 and 9, it can be deduced that higher velocities lead to a better purity of the final bed, but at the same time they provoke a lost of char in the elutriation process, and therefore a poor recovery of char. In any case, a carbon rich fraction can not be isolated in a single elutriation experiment.

### III.3. Conclusion of the Experimental Tests

The series of tests have proven that the wood ash is a ternary solid mixture composed of:
1) heavy sand;
2) large and light char rich fraction; and
3) fine and light ash rich fraction.

It has been concluded that such a mixture could not be perfectly separated in either a single elutriation or segregation step.

### IV. Segregation Followed By Elutriation

It has been decided to conduct a combination of the two processes in series: segregation followed by elutriation. In the segregation process, as the first stage, most of the char particles are segregated at the top of the bed. Afterwards, during the second stage (elutriation), the char particles remain in the bed whereas the fine ash rich fraction is elutriated.

### IV.1. Results

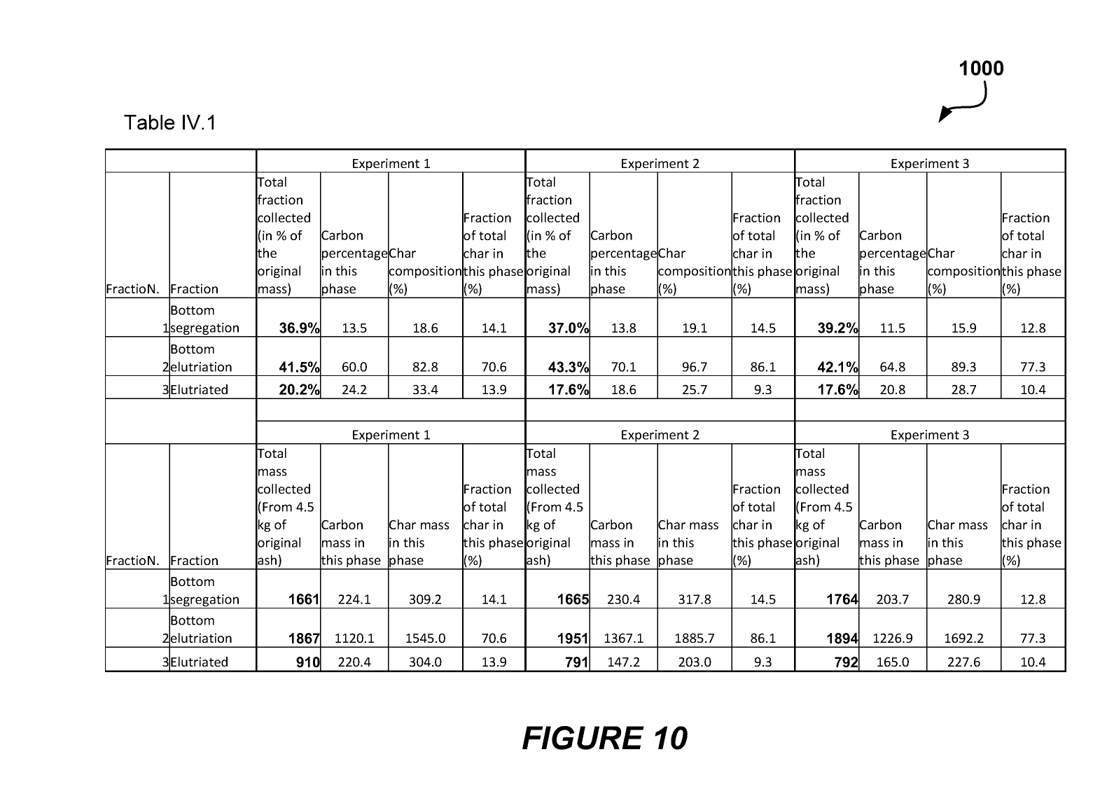

FIG. 10 shows Table IV.1 designated by reference numeral 1000, including experimental results related to the three replicate experiments of segregation followed by elutriation. These three experiments show consistent results with an acceptable reproducibility.

With this two stage separation process, it has been possible to separate the original wood ash in three fractions: the bottom segregation fraction, the bottom elutriation fraction and the elutriated fraction.

The bottom segregation fraction is mainly composed of little stones and large wood particles. It represents about 38% in mass of the original wood ash and has a char content of about 18%; about 13% of the char contained in the wood ash goes to this fraction.

The bottom elutriation fraction is mainly composed of large carbonaceous black particles. It represents about 0% of the original wood ash and has a high content of char of about 90%. More than 78% of the char contained in the original wood ash is recovered in this phase.

The third phase is composed of fine light particles which leave the column during elutriation. Although this fraction is in a smaller amount, its char content of about 30% is relevant, and therefore about 11% of the original char goes to this fraction.

The combination of the two processes is therefore capable of isolating a fraction with a high concentration of char with high recovery efficiency, the fraction represented by the bed material collected after the elutriation experiment.

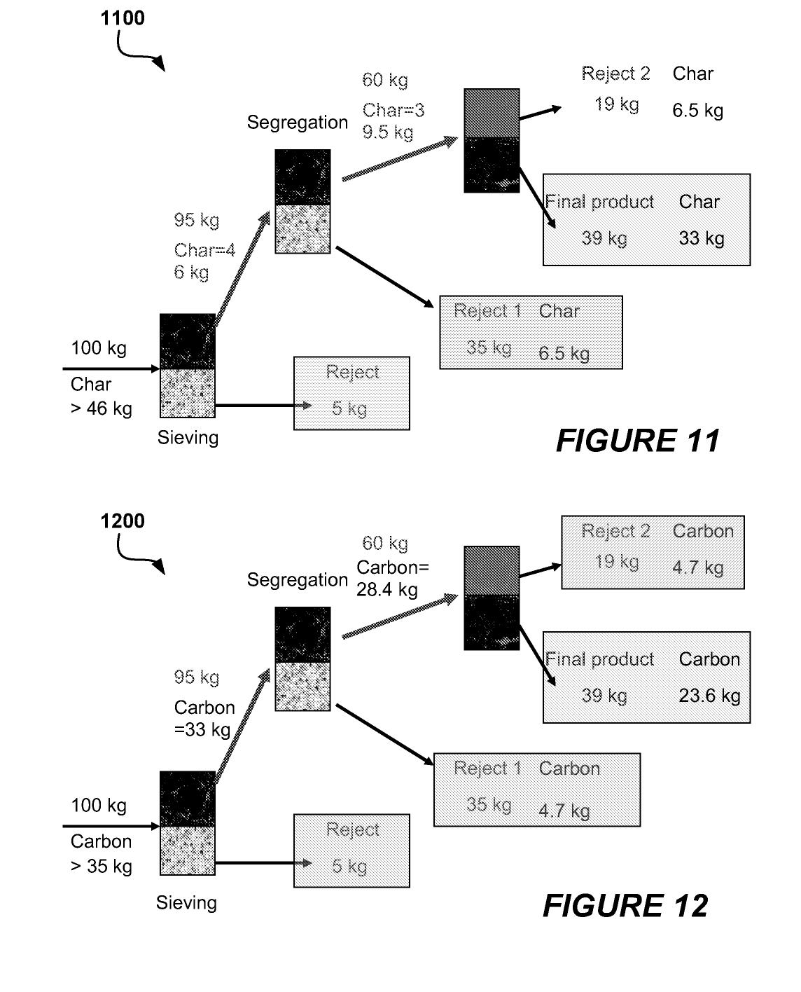

FIGS. 11 and 12 show the product distribution normalized for 100 kg of original wood ash.

FIG. 11 shows a diagram 1100, illustrating char partition in a segregation followed by elutriation process. FIG. 12 shows a diagram 1200, illustrating carbon partition in a segregation followed by elutriation process.

### IV.2. Conclusions And Recommendations

Fluidized bed segregation can remove small stones from the mixture of biochar and fine ashes. Elutriation can separate the fine ash from a mixture of biochar and small stones. Relatively pure biochar can be obtained by combining segregation and elutriation in sequence.

The combined process separates the original wood ash in three fractions:

1) The bottom segregation fraction is mainly composed of little stones.

2) The bottom elutriation fraction is mainly composed of large carbonaceous black particles.

3) The third phase is mainly composed of fine light ash particles which leave the column during elutriation.

The bottom elutriation fraction represents 40% of the original wood ash and has a high content of char (about 90%). More than 78% of the char contained in the original wood ash is recovered in this phase. It represents the desired product of the separation process.

Thus, a method of the embodiments of the invention for extracting biochar from wood ash has been provided.

What is claimed is:

1. A method for separating biochar from wood ash substantially as described and illustrated herein, with particular reference to the drawings and experimental results.
